(19) United States
(12) Patent Application Publication
(10) Pub. No.: US 2018/0068384 A1
(43) Pub. Date: Mar. 8, 2018

(54) SYSTEM AND METHOD TO FACILITATE MERCHANDISE TRANSACTIONS

(71) Applicants: COREY COHEN, Demarest, NJ (US); Rudy Smith, Riverside, CT (US); Arthur Cohen, Demarest, NJ (US)

(72) Inventors: COREY COHEN, Demarest, NJ (US); Rudy Smith, Riverside, CT (US); Arthur Cohen, Demarest, NJ (US)

(21) Appl. No.: 15/256,031

(22) Filed: Sep. 2, 2016

(51) Int. Cl. G06Q 40/02; G06Q 20/24; G06Q 20/14

(52) U.S. Cl. CPC G06Q 40/025; G06Q 20/14; G06Q 20/24

(57) ABSTRACT

A method includes providing, by an online shopping platform, an online store for purchasing gift cards, receiving a selection of a gift card of a first value by a consumer, presenting a term sheet and an install payment schedule to the consumer, in response to receiving an approval by the consumer with respect to the term sheet and the install payment schedule, providing a form to the consumer to receive data relating to a credit card of the consumer, in response to receiving the data, transmit a pre-authorization request to a credit card processor, wherein the pre-authorization request asks for an authorized amount larger than the first value, in response to receiving an approval of the pre-authorization request, charging a first install payment to the credit card and placing an amount equal to the remaining install payments on hold.

### CROSS-REFERENCE TO RELATED APPLICATIONS

This application claims the benefit of U.S. Provisional Application No. 62/213,999, entitled “System and Method to Facilitate Merchandise Transactions”, filed Sep. 3, 2015, the entirety of which is incorporated by reference as if fully set forth herein.

### TECHNICAL FIELD

This disclosure relates to facilitating merchandise transactions between consumers and merchants, in particular, to systems and methods to enable consumers to leverage their credit limits to purchase gift cards issued by merchants and pay back in install payments at zero or reduced interest rates.

### BACKGROUND

Consumers can shop retail stores (such as book stores or grocery stores) and service providers (such as hotels and restaurants) with credit cards. Credit cards include different brands issued by financial institutions (such as banks or credit unions) or stores (such as Macy's®) in collaboration with credit card processors (such as Visa®, MasterCard®, American Express®, or Discover®). Credit cards can come in different forms including debit cards, pre-paid debit cards, unsecured credit cards, or secured credit cards. Consumers also can use mobile devices (such as Apple Pay™) or other mobile-initiated pay systems that are linked to consumer's credit card accounts to make purchase.

A consumer can apply for a credit card with an establishment (such as a financial institution or a store). The establishment may examine the consumer's credit history (such as the consumer's FICO score) and decide whether to issue a credit card to the consumer. If the establishment decides that the consumer is credit worthy, the establishment may issue a credit card to the consumer. To issue the credit card, the establishment may create a credit card account with a credit limit for the consumer. The credit limit represents the upper limit that the consumer can charge to the credit card.

The consumer may use the credit card for purchases via credit card processors and receive a monthly statement showing these charges and a total amount that the consumer needs to pay back to the establishment. In the event that consumer does not pay off the full amount of the monthly credit card statement, the consumer owes a credit card debt to the establishment that can charge an interest at a pre-agreed rate for the owed credit card debt.

### BRIEF DESCRIPTION OF THE DRAWINGS

The present disclosure is illustrated by way of example, and not by way of limitation, in the figures of the accompanying drawings.

FIG. 1 shows a system to facilitate a consumer to make purchases according to an implementation of the present disclosure.

FIG. 2 is a flow diagram illustrating a method to facilitate a consumer to make purchases according to an implementation of the present disclosure.

FIG. 3 is a block diagram illustrating an exemplary computer system according to some implementations of the present disclosure.

### DETAILED DESCRIPTION

Consumer 1 and consumer 2 both want to go to a store or retailer and buy a new computer. Consumer 1 and consumer 2 both identify the new computer and the retailer from which they want to buy that computer. Neither consumer can afford to buy the computer outright because neither consumer has enough cash on-hand. Consumer 1 buys the new computer at the retailer and charges it on a credit card. The problem is that once consumer 1 carries that balance on the credit card, consumer 1 will pay a lot of interest before the computer is actually paid off. This means that if consumer 1 pays down that debt over time, they may pay twice as much for the new computer including the original amount and the interest by the time the debt is paid off.

When a consumer carries a credit card debt (or balance) for a credit card issued to the consumer, the consumer is charged with an interest for the credit card debt. The interest rate may vary based on many factors, but credit card interests are typically very high (e.g., about 15% or higher) because credit card debts are commonly not secured with collaterals. The high credit card interest rate can be a severe burden on the consumer. Under certain situations, the accumulated interest over a long time may be more than the underlying debt.

Consumer 2, using the various implementations of the present disclosure, buys a computer with a retailer gift card. Implementations of the present disclosure include systems and methods that may level the credit playing field between consumers and establishments that issue credit cards to consumers by allowing consumers who already possess credit cards (either secured or unsecured) to use the system to make purchases at stores of their choices and pay back with install payments at no interest or reduced interest. This solves the problem of a high interest burden on the consumer.

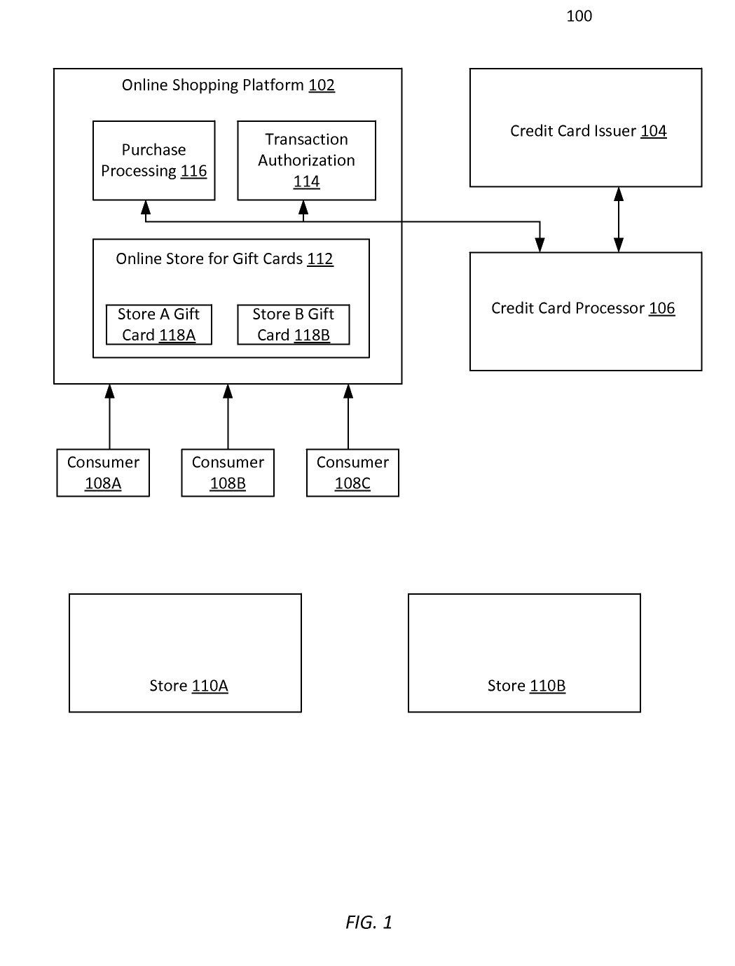

FIG. 1 shows a system 100 to facilitate a consumer to make purchases according to an implementation of the present disclosure. As shown in FIG. 1, system 100 may include an online shopping platform 102 that may be communicably connected to credit card transaction processors (such as Visa, Master Card, American Express, or Discover) which may, in turn, be connected to credit card issuers 104 (such as banks, credit unions, or stores). Consumers 108A-108C may want to purchase merchandise from stores 110A-110B using credit cards issued by credit card issuers 104. Instead of making the credit card purchase directly with the stores 110A-110B, consumers 108A-108C may transact the purchase through online shopping platform 102 that belongs to a business acting as an intermediate between consumers 108A-108C to facilitate the transaction. In one implementation, stores 110A-110B may sell gift cards that may be used as cash equivalents to make purchases at stores 110A-110B. The gift cards 118A-118B may be used to purchase different merchandise sold at stores 110A-110B. Instead of purchasing merchandise directly from stores 110A-110B directly, consumer 108A-108C may first purchase a store gift card 118A, 118B from an online store 112 associated with online shopping platform 102 with a credit card. If consumers 108A-108C pass the approval process of online shopping platform 102 and successfully purchase the store gift card 118A, 118B, online shopping platform 102 may establish a creditor and debtor relationship with consumers 108A-108C who may pay back the debt to the intermediate business owes online shopping platform 102 with install payments. Further, consumers 108A-108C may use the gift cards 118A, 118B to make the intended purchases at stores 110A-110B.

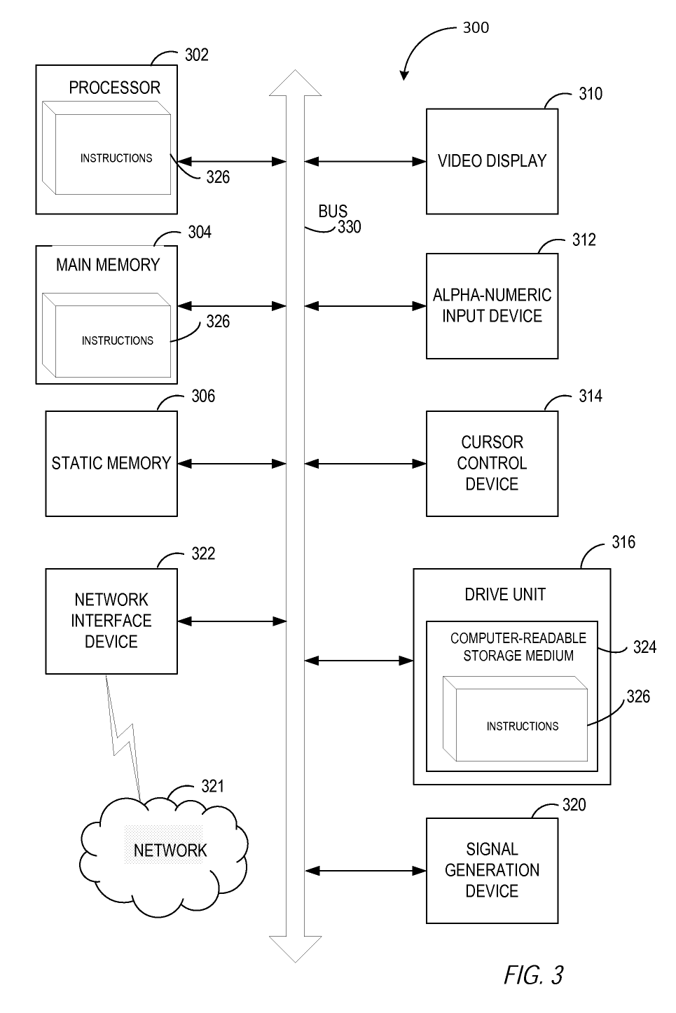

In one implementation, online shopping platform 102 may be implemented on a computer server including hardware components (such as a hardware processing device, memory, and network cards) as shown in FIG. 3. The processing device of online shopping platform 102 may execute software applications to perform different functions to complete the gift card purchase by consumers 108A-108C. In one implementation, online shopping platform 102 may include an online store 112 for consumers 108A-108C to purchase store gift cards 118A-118B. Online store 112 may include a user interface for consumers 108A-108C to sign up with online shopping platform 102, select store gift cards 118A-118B with certain values that may be used to purchase merchandise at stores 110A-110B, and submit credit card information to create the creditor/debtor relationship between online shopping platform 102 and consumers 108A-108C.

Online shopping platform 102 may further include a transaction authorization application 114 and a gift card purchase processing application 116. In one implementation, consumers 108A-108C may first register with online shopping platform 102 as a member to the platform. To register, consumers 108A-108C may need to submit their identification information including full names, residential addresses, phone numbers, e-mail addresses, birth dates, and/or full or partial social security numbers. Further, to become a member of online shopping platform 102, consumers 108A-108C may also need to pay a member fee (such as $50 per year). Based on the identification information, online shopping platform 102 may verify the identity of consumers 108A-108C to prevent fraudulent activities (such as identity theft).

Once registered with online shopping platform 102, consumers 108A-108C may select a store gift card 118A, 118B of a certain value at online store 112 for purchase. In response to receiving the selection and request by consumers 108A-108C to purchase the store gift card equivalent to a certain amount of money (e.g., $300), the processing device of online shopping platform 102 may execute online store application 112 to present a term sheet and an install payment schedule on a user interface to consumers 108A-108C. The term sheet may specify the contract between consumers 108A-108C and online shopping platform 102. For example, the term sheet may specify that consumers 108A-108C can purchase a store gift card 118A, 118B with a credit card, that consumers 108A-108C are responsible to make install payments according the install payment schedule, and any penalties (such as credit risks and penalty charges) associated with failing to make an install payment according to the install payment schedule. The user interface may also include user interface elements (such as buttons, checkbox, or voice commands) to allow consumers 108A-108C to indicate that they have read the term sheet and approve the term sheet. The install payment schedule may include each payment and timing of these payments. For example, for a $300 gift card that is to be paid back in six install payments, the schedule may indicate six monthly payments at $50 each with the first payment being charged immediately.

If consumers 108 A-108C, after reviewing the term sheet and the install payment schedule, indicate to online store 112 (e.g., by clicking an approval button) their approval of the term sheet and install payment schedule, online shopping platform 102 may present consumers 108A-108C with another user interface, requesting consumers 108A-108C to enter credit card information including credit card numbers, security codes, expiration dates, card holders' names, and billing addresses.

In response to receiving the credit card information, transaction authorization application 114 of online shopping platform 102 may transmit a pre-authorization request to credit card processor 106 to determine whether the credit card still has enough credit line for the gift card purchase. In one implementation, the pre-authorization request may ask for pre-authorization of an amount that is more than the purchase amount. For example, the pre-authorization amount is two times of the purchase amount. An authorization of the higher amount may indicate that consumers 108A-108C still have financial capability to purchase other items after purchasing the gift cards 118A-118B, thus providing an indicator that consumers 108A-108C are credit worthy to online shopping platform 102. For example, if consumers 108A-108C want to buy the $300 store gift card, the pre-authorization request may ask for an authorization of $600. If the pre-authorization request is denied (e.g., due to insufficient credit line) by credit card processor 106, online shopping platform 102 may inform consumers 108A-108C about the refusal to purchase store gift cards 118A-118B. If the pre-authorization request is approved by credit card processor 106, transaction authorization application 114 may place an authorization hold of the approved amount for a period of time (e.g., 7-21 days). Authorization hold is credit card transaction state that may deduct the held amount from the credit card limit and make the deducted amount unavailable for other transactions. The held amount is not a charge to the credit card before a settlement taken place between online shopping platform 102 and credit card processor 106. Typically, settlements occur in batches at specified times (e.g., each night). An authorization hold may become a charge after a settlement to the authorization hold has occurred.

In response to successfully receiving an authorization hold with credit card processor 106, purchase processing application 116 of online shopping platform 102 may proceed to transact the gift card sale to consumers 108A-108C to enable consumers 108A-108C to make purchase with the gift cards 118A-118B at stores 110A-110B. Gift cards 118A-118B can be physical gift cards or electronic gift cards.

In one implementation, the term sheet between consumers 108A-108C and online shopping platform 102 may mandate to charge the first install payment immediately to the credit card and require the consumer to make the second payment within the holding period (e.g., 21 days) to online shopping platform 102. Therefore, upon receiving the approval by consumers 108A-108C, purchase processing application 116 charges the first install payment (e.g., the first $50) immediately with credit card processor 106 but still held the rest amount (e.g., $250) as an authorization hold. If online shopping platform 102 receives the second install payment (e.g., the second $50) from consumers 108A-108C within the holding period of time (e.g., within 21 days), online shopping platform 102 may release the hold of the rest amount with credit card processor 106. Consumers 108A-108C may make subsequent install payments to online shopping platform 102 according to the install payment schedule. If consumers 108A-108C fail to make the second install payment within the holding period of time or fail to pay any subsequent install payments as specified according to the payment schedule, online shopping platform 102 may send the bill to bill collector for collection. In one implementation, as long as consumers 108A-108C make payments according to the install payment schedule, online shopping platform 102 does not charge interests to consumers 108A-108C. Alternatively, online shopping platform 102 may charge an interest at a much lower interest rate. In one implementation, in response to receiving one or more install payments from consumers 108A-108C, online shopping platform may determine that consumers 108A-108C are at certain consumption levels. Further, online shopping platform 102 may cross-sell other discount products or services to consumers 108A-108C including discount travel with cash back rewards, personal travel concierge, hotel discount, dining benefits, movie ticket discounts, and floral arrangement discounts.

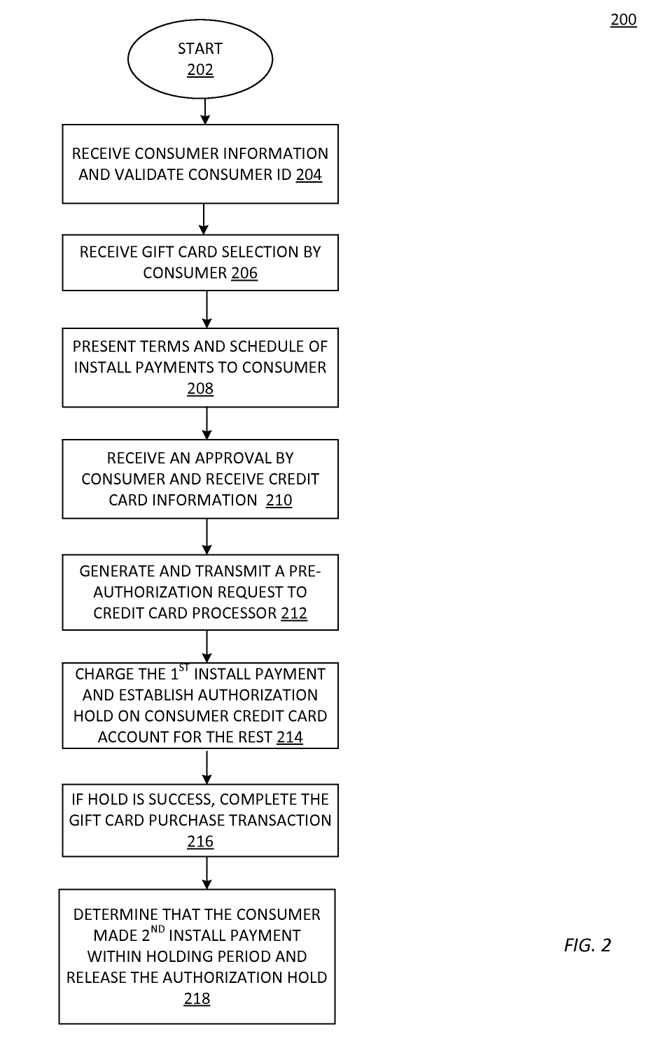

FIG. 2 is a flow diagram illustrating a method 200 to facilitate merchandise transactions according to an implementation of the present disclosure. The method 200 may be performed by processing logic that comprises hardware (e.g., circuitry, dedicated logic, programmable logic, microcode, etc.), software (e.g., instructions run on a processing device to perform hardware simulation), or a combination thereof.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 300 may be performed by the online shopping platform 102 as shown in FIG. 1.

Referring to FIG. 2, at 202, operations may start. At 204, the online shopping platform may receive consumer identification information and application to register as a member of the online shopping platform. The online shopping platform may validate the identity of the consumer and if validated, approve the consumer as a member to the online shopping platform.

At 206, the online shopping platform may receive a gift card selection (including card type and money amount on the gift card) by the consumer via a user interface. The selection indicates that the consumer wants to buy the card with certain value.

At 208, in response to receiving the selection, the online shopping platform may present a term sheet and an install payment schedule to the consumer for approval. The term sheet may specify the business and legal relationship between the online shopping platform and the consumer, and the install payment schedule may specify the specifics about install payments (such as each payment amount and timing).

At 210, the consumer may review and approve the term sheet via the user interface of the online shopping platform. Further, the online shopping platform may present the consumer with a form to enter credit card information. The consumer may enter credit card information through the form.

At 212, the online shopping platform may generate and transmit a pre-authorization request to a credit card processor. The pre-authorization request may include the credit card information and ask for an authorization for an amount of money larger than the face value of the store gift card to be purchase by the consumer. For example, the pre-authorization request may ask for an authorization of two times of the face value of the store gift card. The credit card processor may approve the request if the consumer's credit card

At 214, in response to receiving an approval of the pre-authorization by the credit card processor, the online shopping platform may charge the first install payment to the credit card and place an amount of money equal to the remaining install payments on an authorization hold for a period of time.

At 216, in response to successfully charging the first install payment and placing the rest on authorization hold, the online shopping platform may complete the gift card sale to the consumer to enable the consume to make purchases at the store associated with the gift card.

At 218, the online shopping platform may determine whether the consumer has made the second install payment to the online shopping platform within the holding period of time. In response to determining that the consumer has made the second install payment, the online shopping platform may release authorization hold with the credit card processor. If the consumer fails to pay the second install payment within the holding period of time or fails to pay any subsequent install payments according to the install payment schedule, the online shopping platform may send the unpaid balance to a bill collector for collection.

FIG. 3 illustrates a diagrammatic representation of a machine in the exemplary form of a computer system 300 within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processing device (processor) 302, a main memory 304 (e.g., read-only memory (ROM), flash memory, dynamic random access memory (DRAM) such as synchronous DRAM (SDRAM) or Rambus DRAM (RDRAM), etc.), a static memory 306 (e.g., flash memory, static random access memory (SRAM), etc.), and a data storage device 318, which communicate with each other via a bus 308.

Processor 302 represents one or more general-purpose processing devices such as a microprocessor, central processing unit, or the like. More particularly, the processor 302 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 302 may also be one or more special-purpose processing devices such as an application specific integrated circuit (ASIC), a field programmable gate array (FPGA), a digital signal processor (DSP), network processor, or the like. The processor 302 is configured to execute instructions 326 for performing the operations and steps discussed herein.

The computer system 300 may further include a network interface device 322. The computer system 300 also may include a video display unit 310 (e.g., a liquid crystal display (LCD), a cathode ray tube (CRT), or a touch screen), an alphanumeric input device 312 (e.g., a keyboard), a cursor control device 314 (e.g., a mouse), and a signal generation device 320 (e.g., a speaker).

The data storage device 318 may include a computer-readable storage medium 324 on which is stored one or more sets of instructions 326 (e.g., software) embodying any one or more of the methodologies or functions described herein (e.g., instructions of the online shopping platform 102). The instructions 326 may also reside, completely or at least partially, within the main memory 304 and/or within the processor 302 during execution thereof by the computer system 300, the main memory 304 and the processor 302 also constituting computer-readable storage media. The instructions 326 may further be transmitted or received over a network 374 via the network interface device 322.

While the computer-readable storage medium 324 is shown in an exemplary implementation to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “segmenting”, “analyzing”, “determining”, “enabling”, “identifying,” “modifying” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

1. A method for providing improved merchandise transactions to a consumer by facilitating merchandise transactions by the consumer using a purchased store gift card for a particular merchant, the method comprising:
receive and validate consumer information;
receive a consumer election of a store gift card having a predetermined value;
generate and transmit a pre-authorization request to a third party credit card processor for the predetermined value;
in response to an a first approval by the third party credit card processor and a second approval by the consumer, charge a first install payment for a portion of the predetermined value and establish an authorization hold for the balance of the predetermined value with the third party credit processor;
when the authorization hold for the balance of the predetermined value is established, then complete a transaction of the card elected by the consumer and send the consumer the store gift card comprising the predetermined value;
if the consumer pays a second install payment for a second portion of the predetermined value of the store gift card, then release the authorization hold for the balance of the predetermined value, or if the consumer does not pay the second install payment for the second portion of the predetermined value of the store gift card, then send to a bill collector for collection the second portion of the predetermined value of the card.

2. The method of claim 1, wherein validate consumer information comprises validating consumer identification information, comprising full name, residential address, phone number, email address, birth date, and a full or partial social security number.

3. The method of claim 2, wherein validate consumer information further comprises validating credit card information submitted by the consumer.

4. The method of claim 1, wherein second approval by the consumer comprises the consumer accepting a term sheet and an install payment schedule.

5. The method of claim 1, where in the authorization hold for the balance of the predetermined value indicates that the consumer has a credit line available of at least the predetermined value.

6. The method of claim 1, wherein the second install payment comprises both a dollar value and a pay by date.

7. The method of claim 4, wherein the second install payment comprises both a dollar value and a pay by date according to the term sheet and the install payment schedule.
